(19) United States
(12) Patent Application Publication
(10) Pub. No.: US 2024/0381463 A1
(43) Pub. Date: Nov. 14, 2024

(54) WIRELESS CONNECTION CONTROL METHOD, WIRELESS CONNECTION CONTROL APPARATUS AND PROGRAM

(71) Applicant: NIPPON TELEGRAPH AND TELEPHONE CORPORATION, Tokyo (JP)

(72) Inventors: Toshiro NAKAHIRA, Tokyo (JP); Motoharu SASAKI, Tokyo (JP); Daisuke MURAYAMA, Tokyo (JP); Shota NAKAYAMA, Tokyo (JP); Takatsune MORIYAMA, Tokyo (JP); Yasushi TAKATORI, Tokyo (JP)

(21) Appl. No.: 18/577,857

(22) PCT Filed: Aug. 18, 2021
(86) PCT No.: PCT/JP2021/030203

§ 371 Date: Jan. 9, 2024

(51) Int. Cl. H04W 76/15; H04W 12/06; H04W 48/20

(52) U.S. Cl. CPC H04W 76/15; H04W 12/06; H04W 48/20

(57) ABSTRACT

A radio connection control method executed by a computer includes: setting, for a second base station to which no terminal is connected, second identification information different from first identification information for connecting to an existing first base station to which a plurality of terminals are connected, as identification information for connecting to the second base station; and notifying some of the plurality of terminals of the second identification information to connect the some of the plurality of terminals to the second base station.

### TECHNICAL FIELD

The present invention relates to a radio connection control method, a radio connection control device, and a program.

### BACKGROUND ART

When radio base stations are distributed evenly throughout an area in order to efficiently secure area coverage, it is conceivable that communication quality in a specific area will deteriorate due to influences such as terminal congestion and shielding. In response to this, a technique for alleviating the deterioration of communication quality by dynamically arranging movable base stations in an area where the communication quality has deteriorated has been studied (NPL 1).

### CITATION LIST

### Non Patent Literature

NPL 1: Takuto Arai, Daisuke Goto, Masashi Iwabuchi, Tatsuhiko Iwakuni, and Kazuki Maruta, “Adaptive Movable Access Point System for Offloading Efficiency Enhancement,” vol. 116, No. 46, RCS2016-43, pp. 107-112, May 2016

### SUMMARY OF INVENTION

### Technical Problem

However, when movable base stations are dynamically arranged, if received power from a movable base station becomes too large for each terminal compared with other base stations, a large number of terminals autonomously connect to the movable base station and an excessive imbalance in terminal connections may occur, resulting in deterioration of communication quality.

FIG. 1 is a diagram for describing the problem of the related art. In FIG. 1, an example is described in which two movable base stations are additionally installed in an environment where three existing base stations and 11 terminals are present. (1) of FIG. 1 illustrates a state before the movable base stations are arranged, and (2) of FIG. 1 illustrates a state after the movable base stations are arranged.

Before the movable base station arrangement (1), there is one terminal connected to the leftmost existing base station, and there are five terminals connected to each of the other two existing base stations. Note that a broken line connecting each terminal and the existing base station indicates a connection relationship between the terminal and the existing base station. In this state, the two existing base stations are congested. Therefore, it is intended to eliminate or mitigate congestion by arranging one movable base station for each of the two movable base stations.

In the related art, the arrangement position of the movable base station is calculated by clustering applied to the ten terminals connected to one of the two congested existing base stations. As a result, movable base stations are installed, for example, as illustrated in (2). In (2), each cluster is indicated by a curved frame line, and an example in which a movable base station is arranged at the center of gravity of each cluster is illustrated.

When signals from a plurality of base stations can be received, a terminal is connected to a base station having the highest received power in a general radio system. Therefore, when the movable base stations are arranged as illustrated in (2), five terminals are connected to one movable base station, and two terminals are connected to the other movable base station. As a result, the congestion of the existing base station that was congested in (1) is eliminated, but congestion occurs in the one movable base station. In this way, according to the related art, there is a likelihood that an excessive imbalance will occur in the number of terminals connected to each base station (existing base station or movable base station).

The present invention has been made in view of the above points, and an object of the present invention is to reduce imbalance in the number of terminals connected to each base station.

### Solution to Problem

In order to solve the above problem, a computer executes a setting step of setting, for a second base station to which no terminal is connected, second identification information different from first identification information for connecting to an existing first base station to which a plurality of terminals are connected, as identification information for connecting to the second base station, and a notification step of notifying some of the plurality of terminals of the second identification information to connect the some of the plurality of terminals to the second base station.

### Advantageous Effects of Invention

It is possible to reduce imbalance in the number of terminals connected to each base station.

### BRIEF DESCRIPTION OF DRAWINGS

FIG. 1 is a diagram for describing the problem of the related art.

FIG. 2 is a diagram illustrating a configuration example of a communication system according to an embodiment of the present invention.

FIG. 3 is a diagram illustrating an example of a hardware configuration of a control station 10 according to the embodiment of the present invention.

FIG. 4 is a diagram illustrating an example of a functional configuration of the control station 10 according to the embodiment of the present invention.

FIG. 5 is a flowchart for describing an example of a processing procedure executed by the control station 10.

FIG. 6 is a diagram illustrating a specific example of a state of terminals connected to existing base stations 30.

FIG. 7 is a diagram illustrating an example of a state of terminals connected to respective base stations after movable base stations are arranged.

FIG. 8 is a diagram illustrating an example of the number of terminals connected to each base station before and after movable base stations are arranged.

### DESCRIPTION OF EMBODIMENTS

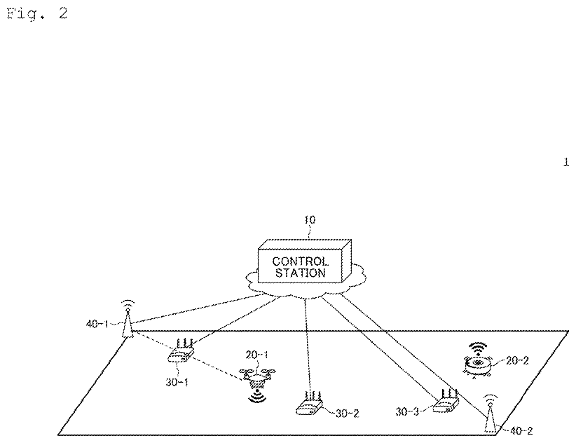

Embodiments of the present invention will be described below with reference to the drawings. FIG. 2 is a diagram illustrating a configuration example of a communication system according to an embodiment of the present invention. As illustrated in FIG. 2, a communication system 1 includes one or more existing base stations 30, one or more movable base stations 20, one or more relay base stations 40, a control station 10, and the like. Note that the base station is a base station (access point) of radio communication (for example, wireless LAN).

The existing base station 30 is an existing base station in the present embodiment. In the present embodiment, the existing base station 30 is not the target of movement, but the existing base station 30 may be movable.

The movable base station 20 is a base station that can move, and is a base station which is newly arranged (whose arrangement position is not determined) in the present embodiment. For example, when communication is congested at a certain existing base station 30, the movable base stations 20 are dynamically arranged. Note that driving means for moving the movable base station 20 is not limited to a specific one. For example, a vehicle, a drone, or the like may be the driving means. The movable base station 20 may be configured to move on rails installed in advance.

The relay base station 40 is a base station that relays communication between the movable base station 20 and the control station 10. The relay base station 40 is connected to the movable base station 20 by radio communication. Therefore, the movable base station 20 can move within a range where radio communication with the relay base station 40 is possible.

Note that, in the following description, when the existing base station 30 and the movable base station 20 are not distinguished from each other, they are simply referred to as “base stations.” Also, although not illustrated, there are a plurality of terminals (hereinafter, terminals 50) which perform communication by radio connection to any of the base stations. Each terminal connects to any of the base stations by autonomous control. The autonomous control is, for example, control in which a terminal connects itself to a base station having relatively high received power in the terminal.

The control station 10 is one or more computers that control a connection relationship between each terminal and each base station (to which base station each terminal is connected). The control station 10 is connected to each existing base station 30 and each relay base station 40 via a network (whether it is wired or wireless), and can collect information about each base station and terminal from each existing base station 30 and each relay base station 40.

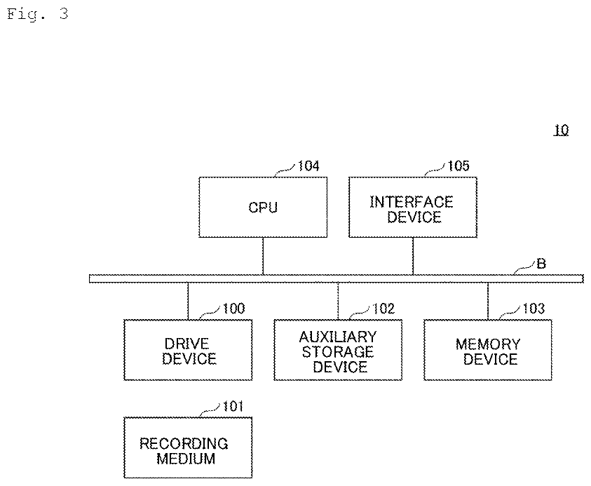

FIG. 3 is a diagram illustrating an example of a hardware configuration of the control station 10 according to the embodiment of the present invention. The control station 10 in FIG. 3 includes a drive device 100, an auxiliary storage device 102, a memory device 103, a CPU 104, an interface device 105, and the like, which are connected to each other by a bus B.

A program for implementing processing in the control station 10 is provided by a recording medium 101 such as a CD-ROM. When the recording medium 101 in which the program is stored is set in the drive device 100, the program is installed from the recording medium 101 to the auxiliary storage device 102 via the drive device 100. However, the program need not necessarily be installed from the recording medium 101, and may be downloaded from another computer via a network. The auxiliary storage device 102 stores the installed program and stores necessary files, data, and the like.

In a case where an activation instruction for the program is given, the memory device 103 reads the program from the auxiliary storage device 102 and stores the program. The CPU 104 executes functions related to the control station 10 according to the program stored in the memory device 103. The interface device 105 is used as an interface for connecting to a network.

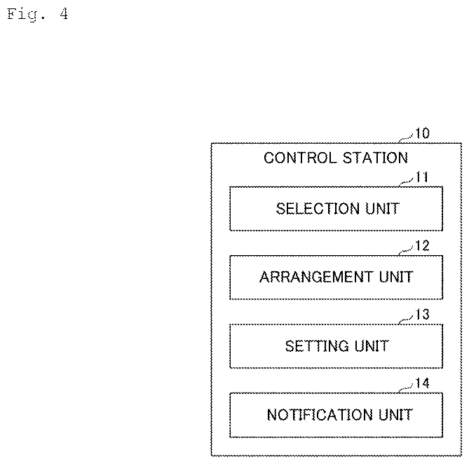

FIG. 4 is a diagram illustrating an example of a functional configuration of the control station 10 according to the embodiment of the present invention. In FIG. 4, the control station 10 includes a selection unit 11, an arrangement unit 12, a setting unit 13, and a notification unit 14. These units are implemented through processing that one or more programs installed in the control station 10 cause the CPU 104 to execute.

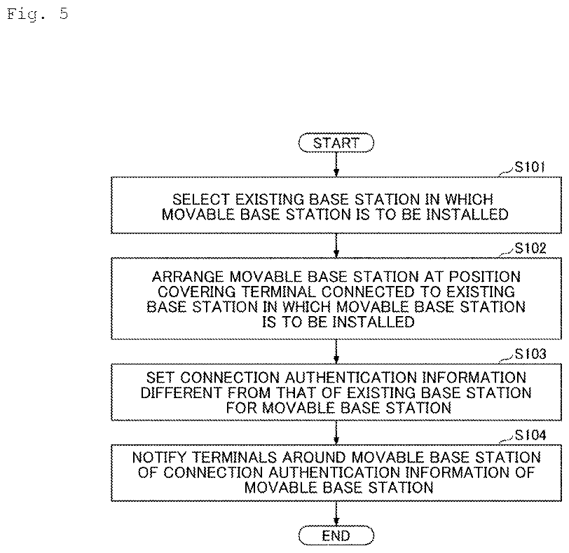

A processing procedure executed by the control station 10 will be described below. FIG. 5 is a flowchart for describing an example of a processing procedure executed by the control station 10.

In step S101, the selection unit 11 selects an existing base station 30 in which the movable base station 20 is to be installed (targeted for load reduction by the movable base station 20) (hereinafter referred to as a “target existing base station 30”) on the basis of the number of terminals connected to each existing base station 30. For example, an existing base station 30 where terminal connection is relatively congested is selected as the target existing base station 30. In this case, the selection unit 11 determines whether or not the terminal connection of each existing base station 30 is congested. For example, the selection unit 11 determines that the existing base station 30 in which the number of terminals that are connected (the number of connected terminals) is greater than or equal to a predetermined threshold value is congested.

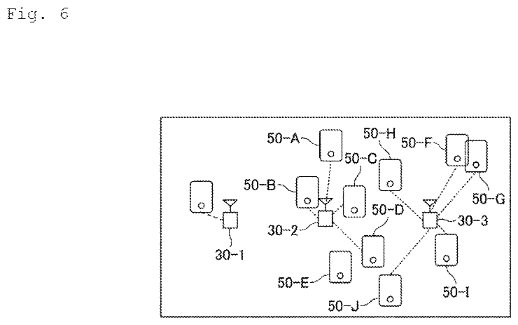

FIG. 6 is a diagram illustrating a specific example of a state of terminals connected to the existing base stations 30. In the present embodiment, it is assumed that two movable base stations 20 are additionally installed in a state where three existing base stations 30 are installed and 11 terminals 50 are connected to one of the existing base stations 30. Note that, in FIG. 6, a broken line connecting the terminal 50 and the base station indicates a connection relationship between the terminal 50 and the base station (to which base station the terminal 50 is connected). Therefore, in the example illustrated in FIG. 6, the number of terminals connected to an existing base station 30-1 is 1, the number of terminals connected to an existing base station 30-2 is 5, and the number of terminals connected to an existing base station 30-3 is 5.

Here, assuming that the threshold value for determining the congestion of the existing base station 30 is 5, it is determined in the example illustrated in FIG. 6 that two existing base stations 30, that is, the existing base station 30-2 and the existing base station 30-3, are congested. Therefore, these two existing base stations 30 are selected as the target existing base stations 30. Note that, when the number of corresponding existing base stations 30 exceeds the number of movable base stations 20 (2 in the present embodiment), for example, when the existing base stations 30 are aligned in the descending order of the number of connected terminals, the existing base stations 30 up to the number of the existing base stations may be selected as the target existing base stations 30.

Alternatively, as another determination method, if the number of connected terminals is included in the top α% among all the existing base stations 30, it may be determined that connection is congested, and if not, it may be determined that connection is not congested. α is a parameter, and, for example, when α=50, the existing base stations 30 of the top 50% are in a congested state.

Alternatively, as another determination method, the existing base station 30 having the number of connected terminals exceeding the average number of connected terminals of all the existing base stations 30 may be determined to be in a congested state.

Subsequently, the arrangement unit 12 controls arrangement of each movable base station 20 so as to be moved to a position covering the terminal 50 connected to each target existing base station 30 (S102). For example, one movable base station 20 is arranged for one target existing base station 30. A position covering the terminal 50 connected to a certain target existing base station 30 means, for example, a position where radio waves reach the terminal 50 with a power greater than or equal to a predetermined value. The position covering the terminal 50 connected to each target existing base station 30 may be determined by a conventional method or another method. For example, the center of gravity of a set of terminals 50 connected to a certain target existing base station 30 may be determined as a position covering (the set of) the terminal 50.

Subsequently, the setting unit 13 sets, for each movable base station 20, connection authentication information different from connection authentication information set for each target existing base station 30 (S103). The connection authentication information means information including at least one of identification information (SSID or the like) of a notification signal of a base station and a password or the like, and is identification information required for connection to the base station. The setting unit 13 may set different connection authentication information for each movable base station 20, or may set common connection authentication information for each movable base station 20.

Subsequently, the notification unit 14 notifies the terminal 50 of the connection authentication information set for the movable base station 20 in order to connect the terminals 50 around each movable base station 20 (within a predetermined distance range from each movable base station) to each movable base station 20 (S104).

Since the terminals 50 around each movable base station 20 are connected to the existing base station 30, the notification unit 14 selects the existing base station 30 adjacent to the movable base station 20 (closest to the movable base station 20 among target existing base stations 30), selects as many terminals 50 as the number of terminals to be connected to the movable base station 20 from among the terminals 50 connected to the existing base station 30, and notifies the selected terminals 50 of connection authentication information for connection to the movable base station 20 (set for the movable base station 20).

At this time, the notification unit 14 calculates the number of terminals to be connected to the movable base station 20 using the number of terminals that are connected to the target existing base station 30 before the movable base station 20 is arranged, the number of terminals that are connected to the movable base station 20 or the existing base station 30 after the movable base station 20 is arranged, and the like.

Each terminal 50 notified of the connection authentication information switches a connection destination to the movable base station 20 related to the connection authentication information.

As another method, the setting unit 13 may set the same connection authentication information as the target existing base station 30 for the movable base station 20 before setting the connection authentication information different from the connection authentication information of the target existing base station 30 for the movable base station 20. In this case, each terminal 50 switches the connection destination to the movable base station 20 if the received power from the movable base station 20 is greater than the received power from the existing base station 30 connected so far. As a result, when the movable base station 20 in which the connection of the terminal 50 is congested (the number of connected terminals exceeds a threshold value) occurs (that is, according to the connection status of the terminal 50 to the movable base station 20), the setting unit 13 may set connection authentication information different from the connection authentication information of the existing base station 30 for the movable base station 20. The notification unit 14 selects some of terminals 50 that are desired to continue connection to the movable base station 20 from among the terminals 50 connected to the movable base station 20, and notifies the selected terminal 50 of the connection authentication information set for the movable base station 20. As a result, the imbalance of terminal connection to the movable base station 20 can be improved.

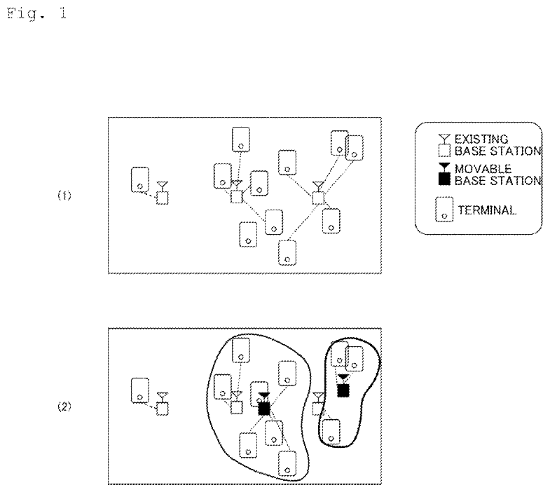

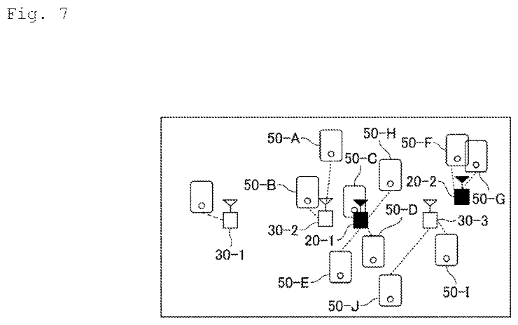

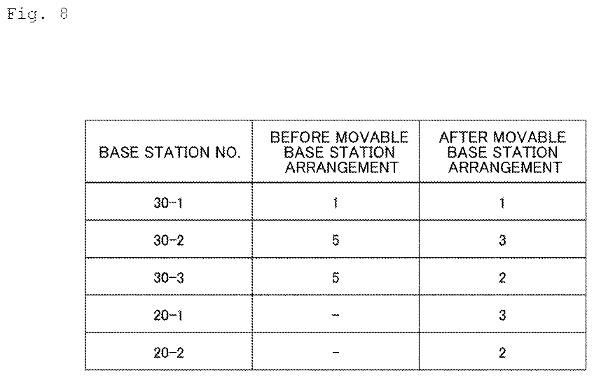

As a result of the above, for example, the connection state of the terminal 50 to each base station becomes as illustrated in FIG. 7. As a result, as illustrated in FIG. 8, the number of terminals connected to each base station is leveled as compared with that of (2) in FIG. 1. Note that, in the table of FIG. 8, the base station number corresponds to the code of each base station. In the table, the values of “before the movable base station arrangement” and “after the movable base station arrangement” for each base station indicate the number of terminals connected to each base station before the movable base station 20 is arranged or after the movable base station 20 is arranged.

As described above, according to the present embodiment, it is possible to reduce the imbalance of the number of terminals connected to each base station. Thus, the improvement of communication quality can be expected.

Note that acquisition and selection of the connection authentication information set for the movable base station 20 by the terminal 50 may be performed by the user using information acquisition means such as a two-dimensional code or NFC, or manual selection from an SSID list displayed by the terminal 50.

Also, when the terminal 50 leaves the coverage area of the movable base station 20, the connection authentication information of the terminal 50 may be deleted.

Note that the present embodiment may be applied not only to the movable base station but also to the control of the fixed base station. For example, connection authentication information different from connection authentication information of another existing fixed base station may be set for a newly installed fixed base station (to which no terminal is connected).

Note that, in the present embodiment, the existing base station 30 is an example of a first base station. The movable base station 20 is an example of a second base station to which no terminal is connected. The control station 10 is an example of a radio connection control device.

Although the embodiments of the present invention have been described in detail above, the present invention is not limited to these particular embodiments, and various modifications and changes are possible within the scope of the gist of the present invention described in the claims.

### REFERENCE SIGNS LIST

1 Communication system
10 Control station
11 Selection unit
12 Arrangement unit
13 Setting unit
14 Notification unit
20 Movable base station
30 Existing base station
40 Relay base station
50 Terminal
100 Drive device
101 Recording medium
102 Auxiliary storage device
103 Memory device
104 CPU
105 Interface device
B Bus

1. A radio connection control method executed by a computer, the method comprising:
setting, for a second base station to which no terminal is connected, second identification information different from first identification information for connecting to an existing first base station to which a plurality of terminals are connected, as identification information for connecting to the second base station; and
notifying some of the plurality of terminals of the second identification information to connect the some of the plurality of terminals to the second base station.

2. The radio connection control method according to claim 1. wherein the notifying includes notifying terminals within a predetermined range from the second base station of the second identification information.

3. The radio connection control method according to claim 1, wherein the setting includes setting the first identification information for the second base station before setting the second identification information for the second base station, and setting the second identification information for the second base station according to a connection status of the terminal to the second base station in a state where the first identification information is set.

4. A radio connection control device comprising:
a memory; and
a processor configured to:
set, for a second base station to which no terminal is connected, second identification information different from first identification information for connecting to an existing first base station to which a plurality of terminals are connected, as identification information for connecting to the second base station; and
notify some of the plurality of terminals of the second identification information to connect the some of the plurality of terminals to the second base station.

5. (canceled)

6. A non-transitory computer-readable recording medium having computer-readable instructions stored thereon, which, when executed, cause a computer to execute a method, the method comprising:
setting, for a second base station to which no terminal is connected, second identification information different from first identification information for connecting to an existing first base station to which a plurality of terminals are connected, as identification information for connecting to the second base station; and
notifying some of the plurality of terminals of the second identification information to connect the some of the plurality of terminals to the second base station.
